(19) United States
(12) Patent Application Publication
(10) Pub. No.: US 2026/0346059 A1
(43) Pub. Date: Nov. 5, 2026

(54) PROTECTIVE BREATHING MASK

(71) Applicant: SATA GmbH & Co. KG, Kornwestheim (DE)

(72) Inventor: Marco SCHÖNEMANN, Wendlingen (DE)

(73) Assignee: SATA GmbH & Co. KG, Kornwestheim (DE)

(21) Appl. No.: 19/485,716

(22) PCT Filed: Dec. 17, 2024
(86) PCT No.: PCT/EP2024/086833

§ 371 Date: Nov. 19, 2025

(30) Foreign Application Priority Data
Feb. 7, 2024 (DE) 10 2024103 373.8

(51) Int. Cl. A62B 18/02; A62B 7/12; A62B 18/08; A62B 23/02

(52) U.S. Cl. CPC A62B 18/025; A62B 7/12; A62B 18/08; A62B 23/02

(57) ABSTRACT

A protective breathing mask includes a mask body; a respiratory air source; and an adapter element for connecting the respiratory air source to the mask body. The adapter element has a first interface and/or a second interface; the mask body has an interface corresponding to the first interface and/or the respiratory air source has an interface corresponding to the second interface; and the adapter element has a closed hollow body which is elastically deformable along the circumference thereof and which is designed to deform in a first direction when a first force is applied to the hollow body such that the releasable connection between the mask body and the adapter element and/or the releasable connection between the adapter element and the respiratory air source is disconnected.

### FIELD OF THE INVENTION

The invention relates to a protective breathing mask, a use of a filter cartridge in a protective breathing mask, a use of a mask body, a use of a closed, elastic, deformable hollow body and an adapter element for connecting a respiratory air source to a mask body.

### BACKGROUND

Protective breathing masks are generally known in the prior art. They are used, for example, in painting work. Protective breathing masks can comprise filters. Depending on the application, these filters have a different structure. For example, a plurality of filters can be arranged in one housing. The housing, also called a filter cartridge, is then connected to the mask, in particular to the mask body. Since filters are consumables, they are replaced after a certain period of use. This involves replacing a single filter, a part of the filter cartridge or even the entire filter cartridge. To do this, the filter cartridge must be removed from the mask body and a new cartridge, or one equipped with new filters, must be reattached to the mask body.

Such protective breathing masks are disclosed, for example, in U.S. Pat. No. 9,700,743 B2 and in EP 2913082 B1.

In this context, it has now become apparent that there is a further need to provide a protective breathing mask, in particular, a need to provide a protective breathing mask with an efficient and cost-effective option for changing filter cartridges.

### SUMMARY OF THE INVENTION

These and other objects, which will be specified upon reading the following description or which may be recognized by a person skilled in the art, are achieved by the subject matter of the independent claims. The dependent claims further develop the central idea of the present invention.

According to a first aspect of the present invention, a protective breathing mask is provided, at least comprising at least one mask body, at least one respiratory air source and at least one adapter element for connecting the respiratory air source to the mask body, wherein the adapter element has a first interface for releasably connecting the adapter element to the mask body and/or a second interface for releasably connecting the adapter element to the respiratory air source, wherein the mask body has an interface corresponding to the first interface and/or wherein the respiratory air source has an interface corresponding to the second interface, wherein the adapter element has a closed hollow body which is elastically deformable along the circumference thereof and is designed to deform in a first direction when a first force is applied to the hollow body such that the releasable connection between the mask body and the adapter element and/or the releasable connection between the adapter element and the respiratory air source is disconnected.

The term “protective breathing mask” refers in particular to a device that can be worn by a person and provides the person with clean air to breathe while worn. The protective breathing mask is in particular a filtering protective breathing mask with filters that filter the air inhaled and/or breathed by the person. The protective breathing mask is in particular a forced-ventilation protective breathing mask. The protective breathing mask is in particular a self-contained protective breathing mask. The protective breathing mask is in particular a blower-type protective breathing mask. The protective breathing mask can in particular have at least one hose connection, in particular at least one air hose coupling. In particular, an air hose can be arranged on the hose connection or the air hose coupling. The air hose can in particular be connected to an air source, in particular a compressed air source, in particular a compressor. The air hose can in particular be connected to a blower unit. The term “connected” can in particular mean directly connected. The term “connected” can in particular mean that further components, in particular filter units, are arranged between the connected components. The term “connected” means in particular fluidically connected, so that air can flow from one component to the other.

The protective breathing mask is in particular a half mask which encloses in particular the mouth and nose of the person wearing the protective breathing mask. The protective breathing mask is in particular a full-face mask which substantially completely encloses the face of the person wearing the protective breathing mask.

The term “enclose” means, in particular, that the protective breathing mask is designed such that enclosed body parts, such as the face, mouth and/or nose, are in particular supplied with clean air. In particular, the protective breathing mask encloses the enclosed body parts, in particular the face, mouth and/or nose, in an airtight manner, i.e. the protective breathing mask fits so tightly to the person's face that no or as little air as possible can escape between the contact surfaces. In particular, the protective breathing mask is a half mask.

The term “mask body” refers in particular to at least a part of the protective breathing mask, which can be designed, for example, to at least partially or completely enclose a person's face. The mask body in particular comprises a hard component. The hard component is in particular a support structure on which in particular components of the protective breathing mask can be arranged. The hard component can in particular consist of a hard, solid and/or substantially rigid plastics material. The hard component can in particular consist of polypropylene (PP). The mask body in particular comprises a soft component. The soft component is in particular a face seal. The soft component can in particular consist of a soft and/or flexible plastics material. The soft component can in particular consist of a thermoplastic elastomer, in particular a thermoplastic styrene block copolymer, in particular styrene-ethylene-butylene-styrene (SEBS). The soft component can in particular be molded onto the hard component. In particular, the hard component can be at least partially overmolded by the soft component.

The term “respiratory air source” refers in particular to a source of respiratory air which can be designed to provide respiratory air to a person. The respiratory air source can provide respiratory air to the person independently of the person's ambient air. Furthermore, the respiratory air source can be designed to provide respiratory air in environments where the ambient air would impair the person's health. The respiratory air source can comprise an air hose connection. The respiratory air source can comprise an air hose coupling. The respiratory air source can comprise an air hose. The respiratory air source can comprise a respiratory air supply arrangement. The respiratory air source can comprise a filter that is in contact with the ambient air. The respiratory air source can comprise a filter cartridge. The filter cartridge can in particular be designed to filter the ambient air. The respiratory air source can in particular be one of the following: a filter cartridge, an air hose coupling or a filter.

The term “adapter element” means in particular a device which is designed to connect a first element via the adapter, or the adapter element, to a second element, wherein the adapter element is designed in particular to connect the respiratory air source to a protective breathing mask, in particular to a mask body. The adapter element can, in particular, provide two interfaces for a releasable connection. For example, the releasable connection can be designed such that a first latching element on the adapter element engages with a corresponding latching element or counter-latching element on the respiratory air source. For example, the releasable connection can be designed such that a second latching element on the adapter element engages with a corresponding latching element or counter-latching element on the mask body. The adapter element can in particular be permanently connected to the mask body, in particular it can be formed integrally with the mask body. The adapter element can in particular be part of the mask body. The adapter element can in particular be permanently connected to the respiratory air source, in particular it can be formed integrally with the respiratory air source. The adapter element can in particular be part of the respiratory air source. The adapter element can in particular be part of the filter cartridge. The adapter element can in particular consist of a rigid plastics material. The adapter element can in particular consist of polypropylene (PP). In particular, the adapter element can be releasably connected or connectible to the mask body. In particular, the adapter element can be releasably connected or connectible to the respiratory air source. In particular, the adapter element can be releasably connected or connectible to the mask body and non-releasably connected or connectible to the respiratory air source. In particular, the adapter element can be permanently connected or connectible to the mask body and releasably connected or connectible to the respiratory air source. Preferably, the adapter element can be releasably connected or connectible to the mask body and releasably connected or connectible to the respiratory air source.

The term “first interface” refers in particular to an interface for releasable connection, wherein the first interface can be designed to be releasably arranged on a corresponding interface on the mask body.

The term “second interface” refers in particular to an interface for releasable connection, wherein the second interface can be designed to be releasably arranged on a corresponding interface on the respiratory air source.

The protective breathing mask can have only the first interface or only the second interface. The protective breathing mask can have both the first interface and the second interface. The protective breathing mask can have additional interfaces.

The term “hollow body” refers in particular to a structurally designed, elastically deformable body with a continuous cavity. The hollow body can be deformed in a first direction, wherein pressure is applied to a first side of the hollow body and a third side of the hollow body opposite the first side, so that the releasable connection between the adapter element and the mask body and/or the releasable connection between the adapter element and the respiratory air source is disconnected or released.

For example, the hollow body can be designed as a ring body that surrounds the hollow region in a ring shape. The ring body itself can have significantly smaller dimensions in terms of its thickness or height than its diameter or its length and width, so that the cavity formed by the hollow body can also have a significantly larger diameter or a significantly greater length and a significantly greater width than its thickness or height, which is defined by the thickness or height of the ring body. The hollow body is in particular designed to be closed. The hollow body has no arms with free ends. In other words, when closed, the hollow body is not designed as a clamp or the like. The closed design can have a positive effect on the stability and service life of the adapter element.

In particular, the first direction can be a direction in which a first force is applied to the hollow body. In particular, the first direction can be a direction in which the hollow body deforms when the first force is applied.

In particular, the first force is a compressive force. In particular, the first force is a force directed toward the interior of the hollow body.

In particular, the hollow body can be compressed by applying force to one side of the hollow body or to two opposite sides, whereupon the hollow body deforms in one direction. In particular, the direction in which the hollow body deforms is different from the direction(s) in which force is applied to the two opposite sides. In particular, a side of the hollow body deforms which is different from the sides to which force is applied, in particular those which are compressed by applying force. In particular, the side deforms outward, in particular away from the side of the hollow body opposite the deforming side. In particular, force is exerted on a first side of the hollow body and/or on a third side of the hollow body opposite the first side. In particular, force is exerted in two opposite directions. In particular, the first side and the third side are moved slightly toward one another. In particular, the hollow body is compressed on the first side and the third side. As a result, a second side of the hollow body deforms, which is arranged in particular between the first side and the third side of the hollow body. In particular, the second side deforms in a direction away from the center of the hollow body, in particular in the direction opposite the center of the hollow body. In particular, the second side deforms in a direction substantially perpendicular to the direction and/or directions in which force is exerted on the first side and/or the third side. In particular, the second side deforms in a direction substantially perpendicular to the directions in which the first side and the third side are compressed. This allows the releasable connection between the adapter element and the mask body and/or the releasable connection between the adapter element and the respiratory air source to be disconnected or released. Preferably, only the releasable connection between the adapter element and the respiratory air source is disconnected or released. Preferably, this does not disconnect or release the releasable connection between the adapter element and the mask body. In particular, the above-mentioned releasable connection is disconnected or released by deformation, in particular moving away, in particular bulging, in particular deflecting, of only a single side of the hollow body. In particular, the hollow body is designed to deform in one direction when a first force is applied to one side of the hollow body or to two opposite sides of the hollow body such that the releasable connection between the mask body and one side of the adapter element and/or the releasable connection between one side of the adapter element and the respiratory air source is disconnected or released, wherein the side of the adapter element whose connection to the mask body or the respiratory air source is disconnected or released is different from the side(s) to which the first force is applied.

As already described above, the adapter element can be permanently connected to the mask body, in particular it can be designed in one piece with the mask body.

As already described above, the adapter element can be permanently connected to the respiratory air source, in particular it can be formed integrally with the respiratory air source.

By providing an elastic and closed hollow body as an adapter element, which encompasses the respiratory air supply cross section, the invention allows for a stable connection between the mask body and the respiratory air source as well as a simple way of releasing the respiratory air source from the adapter element and/or releasing the adapter element from the mask body. On account of the inventive structural design of the elastic hollow body, the connection between the respiratory air source and the adapter element can be released by simply pressing on the adapter element in one direction.

According to one embodiment of the protective breathing mask according to the invention, the hollow body of the adapter element can be designed to deform in a first direction when a first force is applied to the hollow body such that the releasable connection between the mask body and the adapter element is disconnected, and to deform in a second direction when a second force is applied to the hollow body such that the releasable connection between the adapter element and the respiratory air source is disconnected.

In particular, the first direction can be a direction in which a first force is applied to the hollow body. In particular, the first direction can be a direction in which the hollow body deforms when the first force is applied. In particular, the second direction can be a direction in which a second force is applied to the hollow body. In particular, the second direction can be a direction in which the hollow body deforms when the second force is applied.

In particular, the first force and/or the second force is a compressive force. In particular, the first force and/or the second force is a force directed toward the interior of the hollow body.

Protective breathing masks generally have a longer service life than filter cartridges. Filter cartridges must be replaced repeatedly during the service life of the protective breathing mask. Protective breathing masks with air hoses are also used. The air hose coupling must also be regularly removed from the protective breathing mask and reattached. These assembly processes of the air hose coupling and/or filter cartridge as the respiratory air source lead to wear at the corresponding interface on the mask body. This wear, in turn, significantly shortens the service life of the mask body and thus the protective breathing mask. The invention solves this problem by providing an adapter element between the mask body and the respiratory air source. This shifts the wear from the interface of the mask body to the second interface of the adapter element.

Because the hollow body of the adapter element is designed to deform in a first direction when a first force is applied to the hollow body such that the releasable connection between the mask body and the adapter element is disconnected, and to deform in a second direction when a second force is applied to the hollow body such that the releasable connection between the adapter element and the respiratory air source is disconnected, both the connection between the mask body and adapter element and the connection between the adapter element and the respiratory air source can be easily released. Conversely, the elastically deformable, closed hollow body also allows for simple assembly of the respiratory air source on the adapter element and/or the adapter element on the mask body. Overall, the present invention allows for simple and efficient assembly and disassembly of the mask body and respiratory air source components through the adapter element. Furthermore, the present invention allows for the reduction of wear on the high-quality mask body by shifting the wear to the more cost-effective adapter element.

In this way, the adapter element can reduce the forces exerted on the protective breathing mask when connecting or disconnecting the respiratory air source, so that defects of the protective breathing mask caused by the forces are at least reduced. Furthermore, wear on an interface of the protective breathing mask, for example, can be reduced, so that the interface of the protective breathing mask can be protected. In this respect, the long-term use of the protective breathing mask can be improved, in particular, by reducing the forces exerted.

Furthermore, the use of different adapter elements makes it possible to use one mask body with different types of air sources, i.e. to arrange different types of air sources on one and the same mask body. In particular, a breathing mask can be converted from a filtering breathing mask to a forced-ventilation breathing mask and vice versa. Furthermore, the use of different adapter elements makes it possible to arrange an air source, e.g. a filter cartridge, on different mask bodies.

According to one embodiment, the first direction in which a first force is applied to the hollow body is different from the second direction in which a second force is applied to the hollow body.

The closed hollow body can in particular have four sides. The first direction refers in particular to the application of the first force on a first side of the closed hollow body. The second direction refers in particular to the application of the second force on a second side of the closed hollow body. The second side is in particular arranged at a 90° offset from the first side.

The term “first direction” can mean “first axis”. The application of the first force can in particular mean the application of force to a first pair of opposite sides of the closed hollow body. In this case, force, in particular compressive force, is applied to one side of the hollow body and at the same time, force, in particular compressive force, is applied to the opposite side of the hollow body, whereby the directions of the forces are opposite. In particular, the opposite sides are compressed along a first axis. The term “second direction” can mean “second axis”. The application of the second force can in particular mean the application of force to a second pair of opposite sides of the closed hollow body. In this case, force, in particular compressive force, is applied to one side of the hollow body and at the same time, force, in particular compressive force, is applied to the opposite side of the hollow body, whereby the directions of the forces are opposite. In particular, the opposite sides are compressed along a second axis. In particular, the second pair of opposite sides is arranged at a 90° offset from the first pair of opposite sides. In particular, the second axis is arranged at a 90° offset from the first axis.

This allows for simplified assembly, since the user must press in one direction, or along one axis, to release the connection between the respiratory air source and the adapter element, and in another direction, or along another axis, to release the connection between the mask body and the adapter element. The required force is in particular the same. The user then simply needs to select the correct force application point in order to release the corresponding element.

According to one embodiment, the hollow body has a plurality of subregions over the circumference thereof, wherein at least one subregion has a reduced cross section compared to the other subregions, so that the at least one subregion with a reduced cross section deforms more strongly than the other subregions when the first force and/or the second force is applied.

Furthermore, the deformation of the subregions can also be understood as, for example, a displacement, which can lead to the release of the first interface or the second interface with the corresponding interface.

The hollow body can be designed such that, like a flexural joint, it can release a relative movement between two rigid body regions of the hollow body through bending.

The at least one subregion with a reduced cross section provides a targeted weakening in the adapter element. This structurally provides a preferred direction for the deformation or displacement of the adapter element.

In this way, the connection between the respiratory air source and the adapter element and/or the adapter element and the mask body can be released as efficiently as possible and with minimal effort.

According to one embodiment, the at least one subregion with a reduced cross section has a concave portion at one end, so that the at least one subregion with a reduced cross section deforms more strongly than the other subregions when the first force and/or the second force is applied.

The hollow body can be designed such that, like a fixed rotary body joint, it can allow rotational movement between the other subregions and the subregion with a reduced cross section, whereby the concave portion can be designed as the fixed rotary body joint. The concave portion points outward, in particular, from the center of the hollow body. In other words, the concave portion represents an indentation on the hollow body or on at least one subregion.

In this way, targeted deformation can be allowed when force is applied, so that the connection can be released as easily as possible.

According to one embodiment, the hollow body has at least one first mounting bevel for the mask body and the mask body has at least one corresponding mounting bevel.

The first mounting bevel facilitates elastic deformation during assembly of the adapter element on the mask body. The two mounting bevels are designed in particular as corresponding snap-in connection elements.

In this way, efficient assembly of the adapter element on the mask body can be ensured.

According to one embodiment, the hollow body has at least one second mounting bevel for the respiratory air source, and the respiratory air source has at least one corresponding mounting bevel.

The mounting bevel facilitates elastic deformation during assembly of the respiratory air source on the adapter element. The two mounting bevels are designed in particular as corresponding snap-in connection elements.

In this way, efficient assembly of the respiratory air source on the adapter element can be ensured. Furthermore, the adapter element can be connected to the respiratory air source or the mask body in a simplified manner such that, during connection or release, the interface of the respiratory air source or the mask body can slide out of the first interface or the second interface of the adapter element and can thus be connected or released with less effort.

According to one embodiment, the hollow body has at least one first groove and the mask body has at least one corresponding counterpart, which are designed to be brought into engagement with one another. According to one embodiment, the hollow body has at least one second groove and the respiratory air source has at least one corresponding counterpart, which are designed to be brought into engagement with one another.

The term “groove” refers in particular to an opening within the hollow body into which the corresponding counterpart of the mask body can engage. Furthermore, the groove can also be designed as a pocket. The groove may extend at least partially along the circumference of the hollow body.

The term “corresponding counterpart” refers in particular to a lug or projection arranged on the mask body or the respiratory air source and designed to engage in the groove. Furthermore, the corresponding counterpart can also be designed as a wedge or a spring.

In particular, all locking receptacles, in particular grooves, which receive the corresponding counterparts, in particular locking projections, in particular lugs, wedges, springs, or other projections, of the respiratory air source for attaching the respiratory air source to the mask body, are arranged in the adapter element or in the hollow body of the adapter element. In particular, no locking receptacles which receive the corresponding counterparts of the respiratory air source are arranged in the mask body.

In this way, for example, a tongue-and-groove connection or a tongue-and-wedge connection can be realized between the hollow body and the mask body or the respiratory air source, wherein such a connection can be designed for the positive connection of the hollow body to the mask body and/or the respiratory air source.

According to one embodiment, the at least first groove and the at least second groove are designed as a common groove.

In this way, an improved positive connection between the hollow body and the mask body or the respiratory air source can be realized, so that the penetration of ambient air around the protective breathing mask can be reduced.

In particular, first locking receptacles on the hollow body for receiving the corresponding counterparts on the respiratory air source are designed as at least two grooves closed on at least four sides. In particular, a second locking receptacle on the hollow body for receiving at least one corresponding counterpart on the respiratory air source is designed as a web that is open on at least one side.

In particular, first locking receptacles on the hollow body are designed such that corresponding counterparts on the respiratory air source can be inserted therein from one side. In particular, a second locking receptacle on the hollow body is arranged such that at least one corresponding counterpart on the respiratory air source can engage therein from above.

This allows for simple assembly of the respiratory air source on the hollow body, and thus in particular on the breathing mask, and ensures a secure hold of the respiratory air source on the hollow body, and thus in particular on the breathing mask.

According to one embodiment, the respiratory air source is a filter cartridge.

In this way, the protective breathing mask can be designed in particular to supply a person wearing the protective breathing mask with filtered ambient air.

According to one embodiment, the respiratory air source is an air hose coupling.

In this way, the protective breathing mask can be designed in particular to supply a person wearing the protective breathing mask with self-contained respiratory air.

According to one embodiment, the mask body has a first laterally open channel segment as a band guide for a headband, and the adapter element has a second laterally open channel segment as a band guide for a headband, wherein the second laterally open channel segment forms a band guide channel in a state in which the adapter element is connected to the mask body.

The terms “first laterally open channel segment” and “second laterally open channel segment” refer in particular to a surface which is designed to guide the headband such that, for example, the headband can be guided over the first laterally open channel segment and/or the second laterally open channel segment. The first laterally open channel segment and/or the second laterally open channel segment can be designed such that the headband coming from a first point on the head of a person wearing the protective breathing mask can be guided over the first laterally open channel segment and/or the second laterally open channel segment in order to be guided back to a second point on the head, so that the protective breathing mask can be held over at least the first point and the second point on the head. The arrangement of the channel segments can form the band guide channel.

In this way, a guide for the headband integrated into the protective breathing mask can be realized, which improves the wearing comfort of the protective breathing mask and/or the sealing of the protective breathing mask against the ambient air of the protective breathing mask.

A further aspect relates to the use of a filter cartridge in a protective breathing mask described above.

A further aspect relates to the use of a mask body in a protective breathing mask described above.

A further aspect relates to the use of a closed, elastically deformable hollow body for connecting a filter cartridge or an air hose coupling or a mask body in a protective breathing mask described above.

A further aspect relates to an adapter element for connecting a respiratory air source to a mask body, wherein the adapter element has a first interface for releasably connecting the adapter element to a mask body and/or a second interface for releasably connecting the adapter element to a respiratory air source; wherein the adapter element has a closed hollow body which is elastically deformable along the circumference thereof and is designed to deform in a first direction when a first force is applied to the hollow body such that a releasable connection between a mask body and the adapter element and/or a releasable connection between the adapter element and a respiratory air source is disconnected.

In one exemplary embodiment of the adapter element according to the invention, the adapter element is permanently connected to a mask body, in particular is formed integrally with a mask body.

In one exemplary embodiment of the adapter element according to the invention, the adapter element is permanently connected to a respiratory air source, in particular is formed integrally with a respiratory air source.

In one exemplary embodiment of the adapter element according to the invention, the hollow body of the adapter element is designed to deform in a first direction when a first force is applied to the hollow body such that a releasable connection between a mask body and the adapter element is disconnected, and to deform in a second direction when a second force is applied to the hollow body such that a releasable connection between the adapter element and a respiratory air source is disconnected.

In particular, said first direction is different from said second direction.

The features described above, including those from different embodiments, can also be combined with one another, resulting in synergistic interactions that go beyond the sum of the individual effects.

The above statements regarding the protective breathing mask according to the invention can apply analogously to the adapter element according to the invention.

### BRIEF DESCRIPTION OF THE DRAWINGS

The invention is explained below using exemplary embodiments, which are described with reference to the following figures:

FIG. 1 shows an exemplary representation of a protective breathing mask according to the invention;

FIG. 2 shows an exemplary representation of an adapter element according to the invention in a first view;

FIG. 3 shows an exemplary representation of an adapter element according to the invention in a second view;

FIG. 4 shows an exemplary representation of a mask body according to the invention; and

FIG. 5 shows an exemplary representation of a filter cartridge according to the invention.

### DETAILED DESCRIPTION

Exemplary embodiments are described and explained below with reference to the figures listed above. Identical reference signs or similar reference sign structures refer to similar components or those that interact.

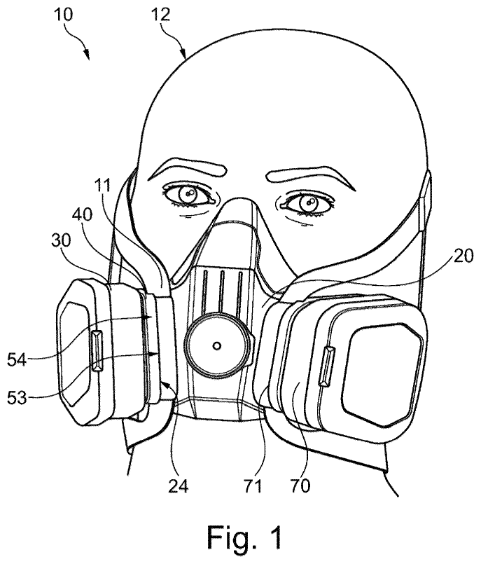

FIG. 1 shows an exemplary representation of a protective breathing mask 10 according to the invention. The protective breathing mask 10 is arranged on a head 12 of a user. The protective breathing mask 10 comprises a mask body 20. The protective breathing mask 10 comprises a filter cartridge 30 as the respiratory air source. The protective breathing mask 10 comprises an adapter element 40 for connecting the filter cartridge 30 to the mask body 20. The protective breathing mask 10 further comprises a second filter cartridge 70, which is also connected to the mask body 20 via a second adapter element 71. The protective breathing mask 10 is attached to the head 12 by a headband 11. The headband 11 is guided in a band guide channel 54. The band guide channel 54 is formed by a first laterally open channel segment 24 of the mask body 20 and a second laterally open channel segment 53 of the adapter element 40. The protective breathing mask 10 allows the user to inhale ambient air through the filter cartridges 30 and 70. The filter cartridges 30 and 70 filter the ambient air and clean it of potentially harmful substances, in particular gases, vapors and/or particles. Alternatively, instead of a filter cartridge as a respiratory air source, an air hose coupling (not shown) can also be connected to the mask body 20 indirectly via the adapter element 40.

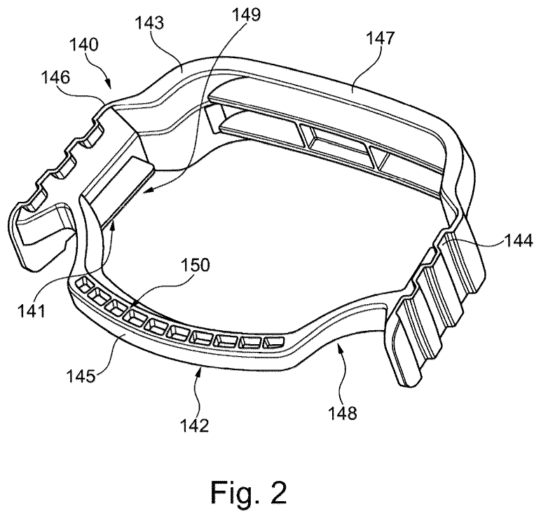

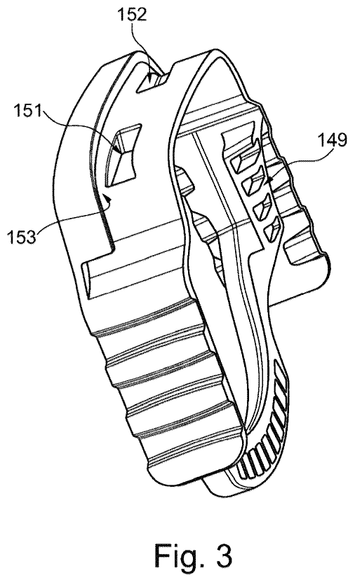

FIGS. 2 and 3 show an exemplary representation of an adapter element 140 according to the invention in two different views. The two views are described together here. The adapter element 140 has a first interface 141 for releasably connecting the adapter element 140 to a mask body (not shown). The adapter element 140 has a second interface 142 for releasably connecting the adapter element 140 to a respiratory air source (not shown).

Furthermore, the adapter element 140 has a closed hollow body 143 which is elastically deformable along the circumference thereof and which is designed to deform in a first direction when a first force is applied to the hollow body 143 such that the releasable connection between the mask body (not shown) and the adapter element 140 is disconnected and/or to deform in a second direction when a second force is applied to the hollow body 143 such that the releasable connection between the adapter element 140 and the respiratory air source (not shown) is disconnected. When force is applied to the subregions 144 and 146, the connection between the adapter element 140 and the filter cartridge is released, in particular because the subregion 145 moves outward, in particular in the radial direction away from the center of the hollow body 143. When force is applied to the subregions 145 and 147, a connection between the adapter element and the mask body is released, in particular because the first interface 141 moves outward, in particular in the radial direction away from the center of the hollow body 143. By simply pressing on two opposite sides, the mask body, the filter cartridge or the air hose coupling can be released from the adapter element. By pressing, the closed elastic hollow body deforms such that the latching connections between the adapter element and the mask body and/or the latching connections between the adapter element and the filter cartridge are released or disengaged. Furthermore, the hollow body 143 has at least one first mounting bevel 149 for the mask body (not shown). Furthermore, the hollow body 143 has at least one second mounting bevel 150 for the respiratory air source (not shown). The snap-in connections are formed in this case by the mounting bevels 149 and 150 on the adapter element 140 and the corresponding mounting bevels on the mask body and on the filter cartridge.

Furthermore, the hollow body 143 has a plurality of subregions 144, 145, 146, 147 over the circumference thereof, wherein at least one subregion 145 has a reduced cross section compared to the other subregions 144, 146, 147, so that the at least one subregion 145 with a reduced cross section deforms more strongly than the other subregions 144, 146, 147 when the first force and/or the second force is applied.

Furthermore, the at least one subregion 145 with a reduced cross section has a concave portion 148 at one end, so that the at least one subregion 145 with a reduced cross section deforms more strongly than the other subregions 144, 146, 147 when the first force and/or the second force is applied.

Furthermore, the hollow body 143 has at least a first groove 151 and a second groove 152, which are designed to be brought into engagement with a corresponding counterpart of the respiratory air source (not shown).

The second laterally open channel segment 153 for the belt guide can be seen in particular in FIG. 3.

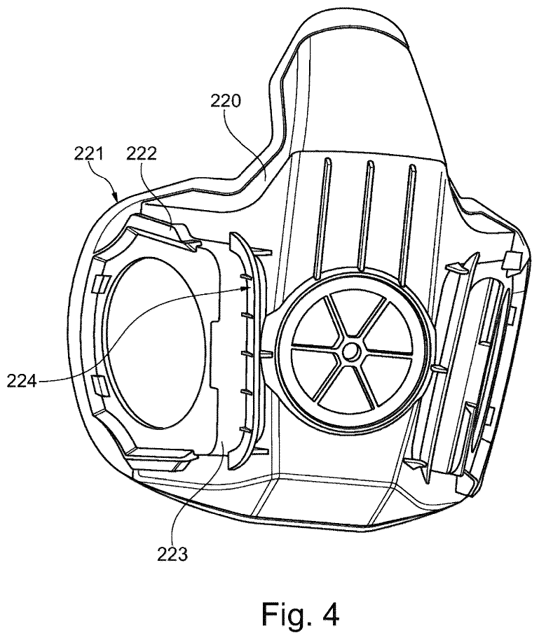

FIG. 4 shows an exemplary representation of a mask body 220 according to the invention. The mask body 220 comprises an interface 221, a mounting bevel 222, a counterpart 223 and a first laterally open channel segment 224. The interface 221 is designed to receive a corresponding interface of an adapter element (not shown). Furthermore, the mounting bevel 222 is designed to receive a corresponding mounting bevel of an adapter element (not shown). In particular, the mounting bevel 222 is engaged under a first interface 141 of the hollow body 143 shown in FIG. 2, in order to attach the adapter element 140 to the mask body 220. When a force is exerted on the subregion 145 and/or on the subregion 147, the first interface 141 moves outward, protrudes from under the mounting bevel 222, and the adapter element 140 can be removed from the mask body 220. Furthermore, the counterpart 223 is designed to receive a corresponding counterpart, in particular a groove, of an adapter element (not shown). Furthermore, the first laterally open channel segment 224 is designed to guide a headband (not shown).

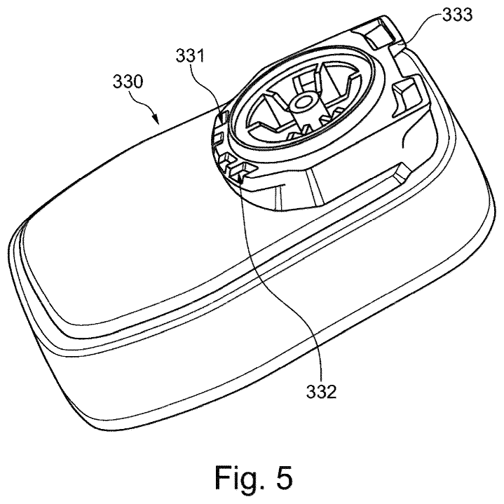

FIG. 5 shows an exemplary representation of a filter cartridge 330 according to the invention. The filter cartridge 330 comprises an interface 331, a mounting bevel 332 and a counterpart 333. The interface 331 is designed to receive a corresponding interface of an adapter element (not shown). Furthermore, the mounting bevel 332 is designed to receive a corresponding mounting bevel of an adapter element (not shown). Furthermore, the counterpart 333 is designed to receive a corresponding counterpart, in particular a groove, of an adapter element (not shown). In particular, during assembly of the filter cartridge 330 on the adapter element 140, which is preferably already arranged on the mask body 220, the counterpart 333 is inserted into the first groove 151 shown in FIG. 3. In particular, the side of the filter cartridge 330 opposite the counterpart 333 is then pressed toward the mask body 220, whereby the interface 331 engages into the second interface 142 shown in FIG. 2, in particular, the interface 331 engages under the second interface 142 shown in FIG. 2. During disassembly, force is exerted on the subregion 144 and/or the subregion 146, whereupon the second interface 142 of the hollow body 143 moves outward and releases the interface 331 of the filter cartridge 330, whereby the filter cartridge 330 can be released from the adapter element 140.

### REFERENCE SIGNS

10 Protective breathing mask
11 Headband
12 Head
20,220 Mask body
24, 224 Mask body first laterally open channel segment
30, 70, 330 Respiratory air source, filter cartridge
40,71, 140 Adapter element
53, 153 Second laterally open channel segment
54 Band guide channel
141 First interface adapter element
142 Second interface adapter element
143 Hollow body
144 Subregion
145 Subregion with reduced cross section
146,147 Subregions
148 Concave portion
149 Adapter element first mounting bevel
150 Adapter element second mounting bevel
151 First groove
152 Second groove
221 Mask body interface
222 Mask body mounting bevel
223 Mask body counterpart
331 Filter cartridge interface
332 Filter cartridge mounting bevel
333 Filter cartridge counterpart

1-22. (canceled)

23. A protective breathing mask comprising:
a mask body;
a respiratory air source; and
an adapter element for connecting the respiratory air source to the mask body,
wherein the adapter element has a first interface for releasably connecting the adapter element to the mask body and/or a second interface for releasably connecting the adapter element to the respiratory air source,
wherein the mask body has an interface corresponding to the first interface and/or the respiratory air source has an interface corresponding to the second interface;
wherein the adapter element has a closed hollow body which is elastically deformable along the circumference thereof and which is designed to deform in a first direction when a first force is applied to the hollow body such that the releasable connection between the mask body and the adapter element and/or the releasable connection between the adapter element and the respiratory air source is disconnected.

24. The protective breathing mask according to claim 23, wherein the adapter element is non-releasably connected to the mask body.

25. The protective breathing mask according to claim 23, wherein the adapter element is non-releasably connected to the respiratory air source.

26. The protective breathing mask according to claim 23, wherein the hollow body of the adapter element is designed to deform in a first direction when a first force is applied to the hollow body such that the releasable connection between the mask body and the adapter element is disconnected, and to deform in a second direction when a second force is applied to the hollow body such that the releasable connection between the adapter element and the respiratory air source is disconnected.

27. The protective breathing mask according to claim 26, wherein the first direction is different from the second direction.

28. The protective breathing mask according to claim 23, wherein the hollow body has a plurality of subregions over the circumference thereof, wherein at least one subregion has a reduced cross section compared to the other subregions, so that the at least one subregion with a reduced cross section deforms more strongly than the other subregions when a force is applied.

29. The protective breathing mask according to claim 28, wherein the at least one subregion with a reduced cross section has a concave portion at one end, so that the at least one subregion with a reduced cross section deforms more strongly than the other subregions when the force is applied.

30. The protective breathing mask according to claim 23, wherein the hollow body has at least one first mounting bevel for the mask body and the mask body has at least one corresponding mounting bevel.

31. The protective breathing mask according to claim 23, wherein the hollow body has at least one second mounting bevel for the respiratory air source and the respiratory air source has at least one corresponding mounting bevel.

32. The protective breathing mask according to claim 23, wherein the hollow body has at least one first groove and the mask body has at least one corresponding counterpart, which are designed to be brought into engagement with one another and/or wherein the hollow body has at least one second groove and the respiratory air source has at least one corresponding counterpart, which are designed to be brought into engagement with one another.

33. The protective breathing mask according to claim 32, wherein the at least one first groove and the at least one second groove are designed as a common groove.

34. The protective breathing mask according to claim 23, wherein the respiratory air source is a filter cartridge.

35. The protective breathing mask according to claim 23, wherein the respiratory air source is an air hose coupling.

36. The protective breathing mask according to claim 23, wherein the mask body has a first laterally open channel segment as a band guide of a headband, and the adapter element has a second laterally open channel segment as a band guide of a headband, wherein the second laterally open channel segment forms a band guide channel in a state in which the adapter element is connected to the mask body.

37. An adapter element for connecting a respiratory air source to a mask body,
wherein the adapter element has a first interface for releasably connecting the adapter element to a mask body and/or a second interface for releasably connecting the adapter element to a respiratory air source,
wherein the adapter element has a closed hollow body which is elastically deformable along the circumference thereof and which is designed to deform in a first direction when a first force is applied to the hollow body such that a releasable connection between the mask body and the adapter element and/or a releasable connection between the adapter element and the respiratory air source is disconnected.

38. The adapter element according to claim 37, wherein the adapter element is non-releasably connected to the mask body.

39. The adapter element according to claim 37, wherein the adapter element is non-releasably connected to the respiratory air source.

40. The adapter element according to claim 37, wherein the hollow body of the adapter element is designed to deform in a first direction when a first force is applied to the hollow body such that a releasable connection between the mask body and the adapter element is disconnected, and to deform in a second direction when a second force is applied to the hollow body such that a releasable connection between the adapter element and the respiratory air source is disconnected.

41. The adapter element according to claim 40, wherein the first direction is different from the second direction.
